(19) United States
(12) Patent Application Publication
(10) Pub. No.: US 2014/0095986 A1
(43) Pub. Date: Apr. 3, 2014

(54) Baseline Alignment

(71) Applicants: Vinay Krishnaswamy, Woodinville, WA (US); Ravipal Soin, Kirkland, WA (US); William Hill, Carnation, WA (US)

(72) Inventors: Vinay Krishnaswamy, Woodinville, WA (US); Ravipal Soin, Kirkland, WA (US); William Hill, Carnation, WA (US)

(21) Appl. No.: 13/632,134

(22) Filed: Sep. 30, 2012

(51) Int. Cl. G06F 17/00

(52) U.S. Cl. 715/243

(57) ABSTRACT

The instant application discloses, among other things, techniques to allow baseline alignment. Aligning baselines across columns may improve readability and aesthetics. Baseline alignment may include having lines of body text, images, titles, or other elements have a common lower horizontal guideline.

### RELATED APPLICATIONS

This application claims priority to provisional application No. 61/525,156 filed Aug. 18, 2011 titled “Method and System for Collaborative Content Publishing and Consumption for Touch Sensitive Devices.”

### FIELD

This disclosure relates to baseline alignment.

### BACKGROUND

The internet provides a foundation for people wishing to share pictures, text, multimedia, or other content with others.

It is often easy for an individual to post pictures or write a blog, although producing a well-designed product often requires special skills, which many users do not have. While designs targeted for paper often were made by experienced designers, applications on computers allowed many more people to publish using their own designs, with readability often being lost.

### SUMMARY

The instant application discloses, among other things, techniques to allow baseline alignment. Aligning baselines across columns may improve readability and aesthetics. Baseline alignment may include having lines of body text, images, titles, or other content elements have a common lower horizontal guideline.

### BRIEF DESCRIPTION OF THE DRAWINGS

FIG. 1 is an example of a system on which Baseline Alignment may be implemented.

FIG. 2 is an example of two columns of text without baselines aligned.

FIG. 3 is an example of two columns of text with baselines aligned.

FIG. 4 is a flow chart for baseline alignment according to one embodiment.

FIG. 5 illustrates a component diagram of a computing device according to one embodiment.

### DETAILED DESCRIPTION

A more particular description of certain embodiments of Baseline Alignment may be had by references to the embodiments shown in the drawings that form a part of this specification, in which like numerals represent like objects.

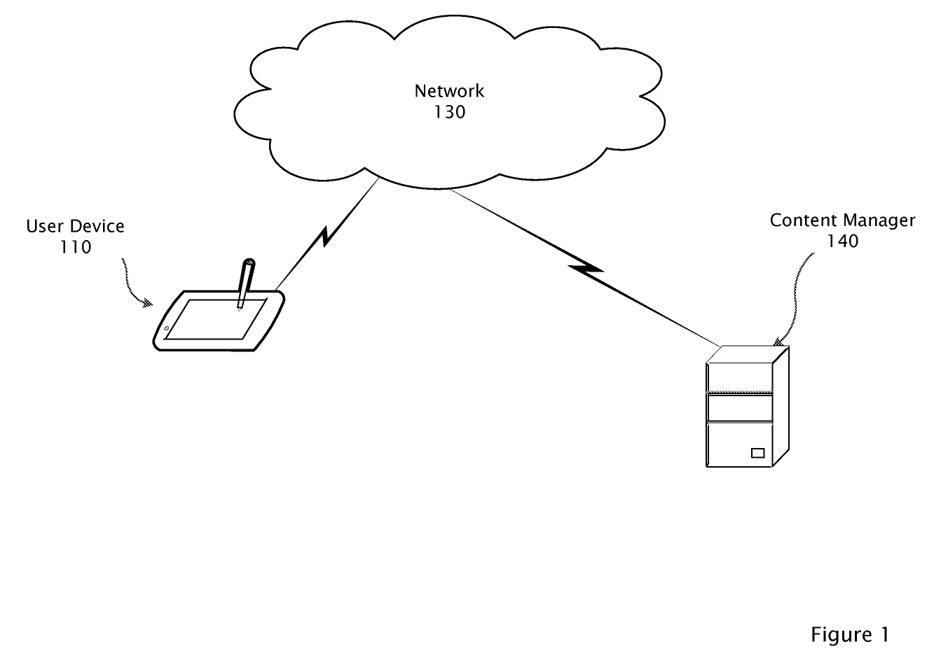

FIG. 1 is an example of a system on which Baseline Alignment may be implemented. A user may design a publication on User Device 110. Software supporting Baseline Alignment may be local to User Device 110, or may be hosted on Content Manager 140. Various types of software may be used for Baseline Alignment, including but not limited to native software running on User Device 110, client-server software running on User Device 110 and Content Manager 140, or software running on Content Manager 140 and serving web pages to User Device 110. In this example, User Device 110 may be used to originate a request for Baseline Alignment to be performed and send it via Network 130 to Content Manager 140. Network 130 may be a local area network, or it may include the Internet. Any type of communication link may be used, or all processing may occur on one device. Other types of data transfer may also be used, such as loading information from User Device 110 onto a portable drive and loading the information onto Content Manager 140.

Content Manager 140 may include one or more computers, and may serve a number of roles, including, but not limited to, storing content and attributes, manipulating content and attributes, and serving content. For example, in one embodiment, Content Manager 140 may include a database with tables to store information about users, user devices, projects, articles, content elements, layouts, layout definitions, and other data that may be relevant to Baseline Alignment.

One skilled in the art will recognize that User Device 110 and Content Manger 140 may be of different designs and capabilities.

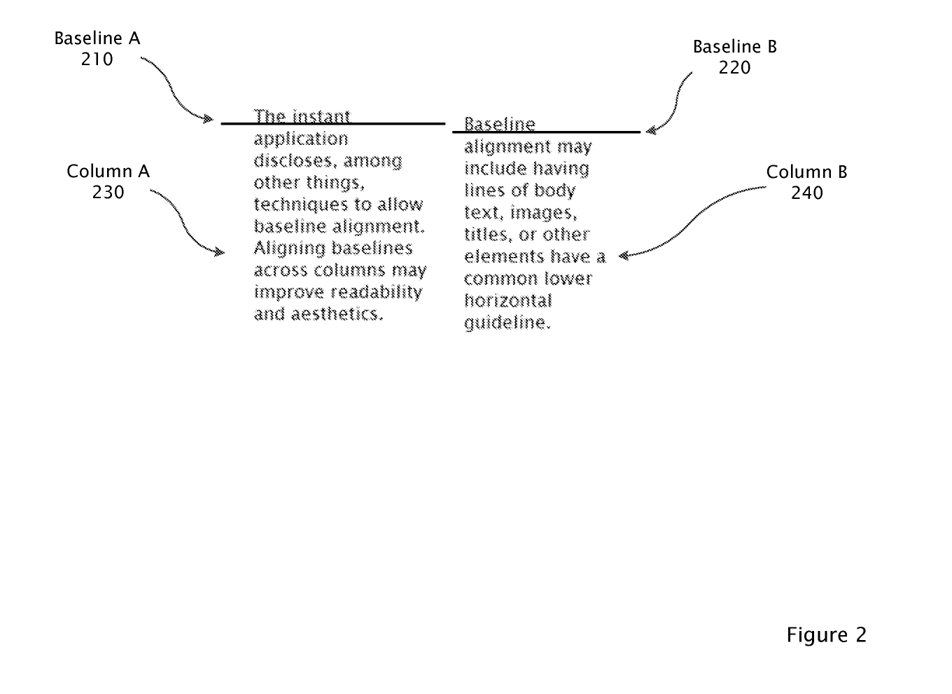

FIG. 2 is an example of two columns of text without baselines aligned. Column A 230 may be aligned to Baseline A 210, while Column B 240 aligns to Baseline B 220. Baseline A 210 and Baseline B 220 are not aligned with each other, which may result in a less-professional appearing publication, and may be more difficult to read.

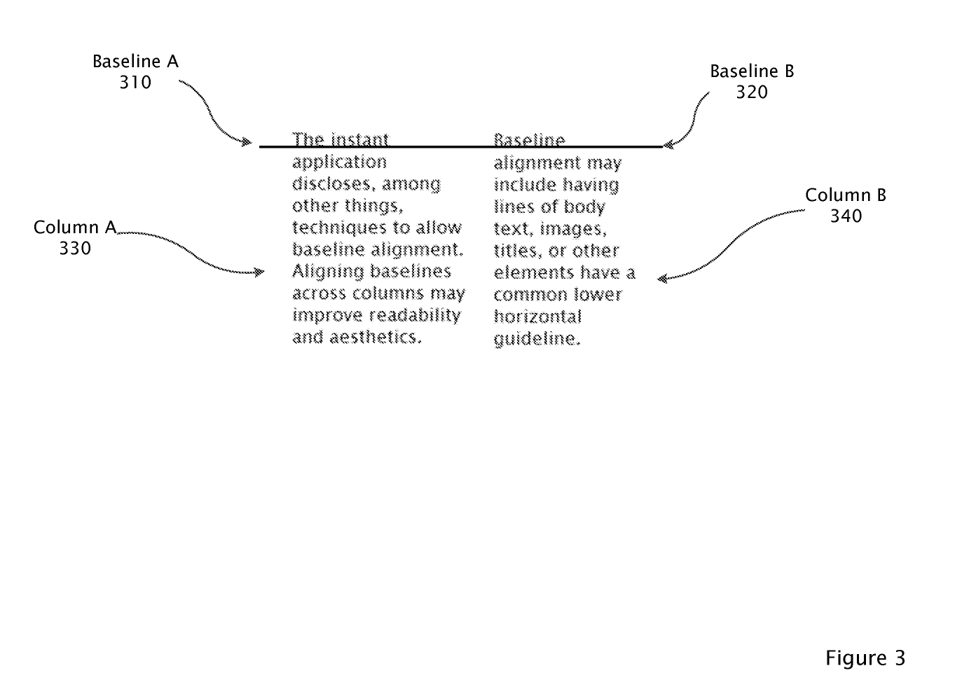

FIG. 3 is an example of two columns of text with baselines aligned. Column A 330 may be aligned to Baseline A 310, while Column B 340 aligns to Baseline B 320. Baseline A 310 and Baseline B 320 are aligned with each other, which may result in a more-professional appearing publication, and readability may be improved.

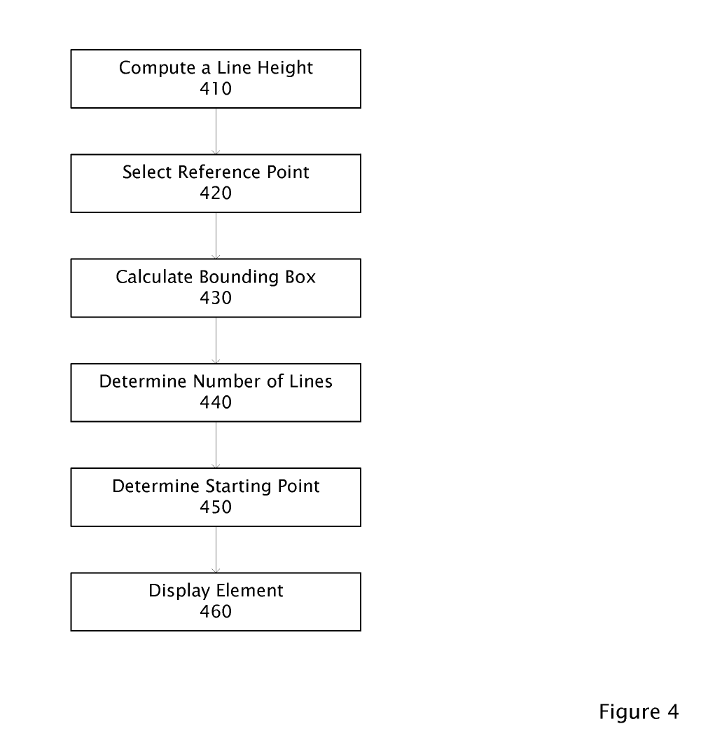

FIG. 4 is a flow chart for baseline alignment according to one embodiment. Baseline Alignment may be performed by creating a virtual dynamic grid. In this embodiment, an arbitrary Reference Point is Selected 420 on the page. A Line Height is Computed 410 based on a font or fonts used on page of a publication. A Bounding Box is Calculated 430 for a content element, such as a column of text or an image, to be placed. A Number of Lines from the Reference Point is Determined 440 and a Starting Point is Determined 450 for the content element which falls inside the Bounding Box. The Content Element may then be Displayed 460.

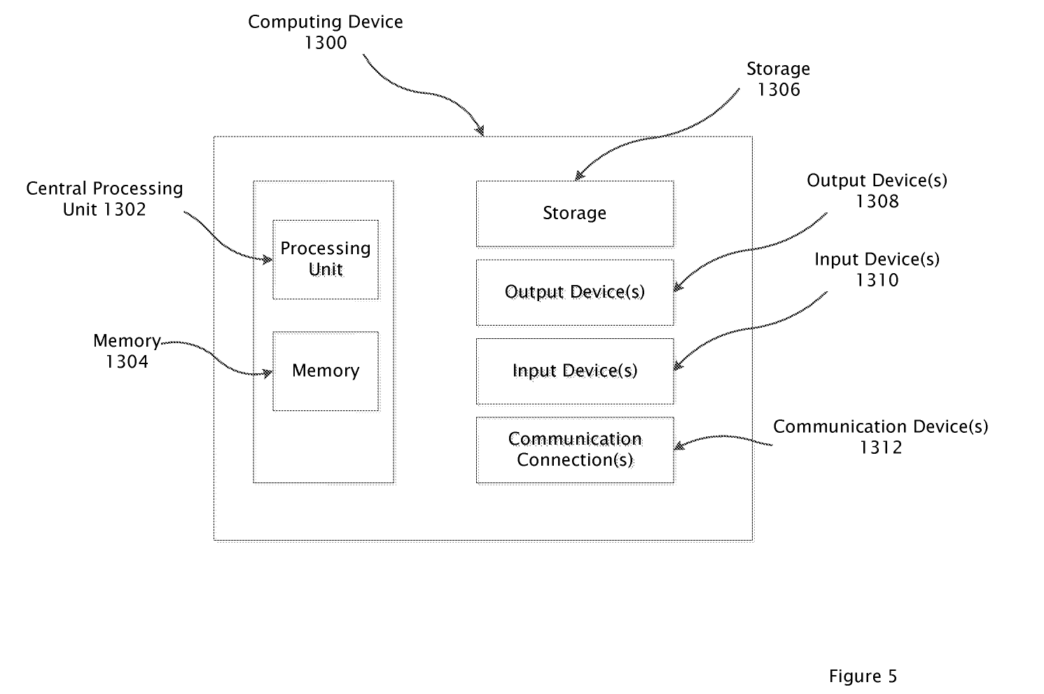

FIG. 5 illustrates a component diagram of a computing device according to one embodiment. The Computing Device (1300) can be utilized to implement one or more computing devices, computer processes, or software modules described herein, including, for example, but not limited to User Device 110, 120 or a Content Manager 140. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, 120 or a Content Manager 140. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
components operable by the processor, comprising:
a reference-point selecting component, configured to select a reference point;
a line-height calculating component, configured to calculate a line height based upon one or more fonts used on a page;
a bounding box calculating component, configured to calculate a bounding box for a content element;
a number-of-lines determining component, configured to determine a number of lines based on the determined line height from a reference point to a point within a bounding box;
a starting point determining component, configured to determine a starting point for a content element based on the point within the bounding box; and
a display component, configured to display a content element in a position based on the determined starting point.

2. The system of claim 1, further comprising:
a starting point re-determining component, configured to re-determine the starting point when an element is moved.

3. A method, comprising:
selecting a reference point on a computer display;
computing a line height on the computer display, based on font sizes used on a design;
calculating a bounding box for a content element to be placed on the computer display;
determining a starting point for displaying the content element based upon the computed line height and the reference point; and
displaying the content element in a position based on the starting point.

4. The method of claim 3, wherein the determining the starting point further comprises determining a number of lines from the reference point to a content line of text which falls within the bounding box.

5. A computer storage medium containing instructions thereon which, when executed by a processor, execute a method comprising:
selecting a reference point on a computer display;
computing a line height on the computer display, based on font sizes used on a design;
calculating a bounding box for a content element to be placed on the computer display;
determining a starting point for displaying the content element based upon the computed line height and the reference point; and
displaying the content element in a position based on the starting point.

6. The method of claim 5, wherein the determining the starting point further comprises determining a number of lines from the reference point to a content line of text which falls within the bounding box.
